(19) United States
(12) Patent Application Publication
(10) Pub. No.: US 2022/0045717 A1
(43) Pub. Date: Feb. 10, 2022

(54) METHODS AND SYSTEMS FOR MAINTAINING THE INTEGRITY OF ELECTRONIC SIGNALS PASSING BETWEEN ENVIRONMENTS WITH DIFFERENT GROUND POTENTIALS

(71) Applicant: James N. BLAKE, Scottsdale, AZ (US)

(72) Inventor: James N. BLAKE, Scottsdale, AZ (US)

(21) Appl. No.: 17/275,857

(22) PCT Filed: Sep. 16, 2019
(86) PCT No.: PCT/US2019/051283

§ 371 Date: Mar. 12, 2021

Related U.S. Application Data
(60) Provisional application No. 62/731,271, filed on Sep. 14, 2018.

(51) Int. Cl. H04B 3/28; H01B 11/12

(52) U.S. Cl. CPC H04B 3/28; H01B 11/125

(57) ABSTRACT

An electrical communications system is described between a first environment and a second environment, having time-varying ground potential differences. The system includes a wire pair for carrying an electrical signal to be communicated from the first environment to the second environment; a first ground shield surrounding the signal carrying wire pair connected to a ground of the first environment; a second ground shield surrounding the signal carrying wire pair connected to a ground of the second environment; and a resistive element connected between the wires in the signal carrying wire pair having a value chosen so as to suppress any natural resonance characteristics of the cable structure.

### RELATED APPLICATION

This application is related to, and claims priority from, U.S. Provisional Patent Application No. 62/731,271, entitled “Maintaining the Integrity of Electronic Signals Passing Between Environments With Highly Different Ground Potentials”, filed Sep. 14, 2018, to James N. Blake, the disclosure of which is incorporated by reference herein.

### TECHNICAL FIELD

The present invention generally relates to electrical substations and, more particularly, to mechanisms and techniques for sending electronic signals between different environments associated with electrical substations.

### BACKGROUND

There are many circumstances in an electrical substation where an AC voltage signal must be passed between two environments having highly different ground potentials. An exemplary situation is the case where an electronics chassis located in a control room must communicate electronically with equipment located outdoors. The control room ground is normally connected to the outdoor ground grid at some point, but the presence of large ground fault currents in the substation will cause the control room ground to be at a very different potential than the outdoor equipment ground during an electrical fault, a difference in potential which could reach up to many thousands of volts.

Thus, the interconnecting cable that passes the signal between the two environments runs through two different ground potentials. Each ground potential capacitively couples into the cable conductors causing the signal carrying conductors to seek an intermediate common mode potential. This common mode potential, differing from either or both grounds by thousands of volts, is liable to damage the equipment on one end or the other of the cable. Even if precautions are taken to avoid voltage spike damage to the equipment (e.g., through the use of spark gaps), a spike in the common mode voltage can cause temporary malfunction to the equipment—precisely at the time that a real fault exists, and thus, often, precisely at the most critical time that the equipment must operate correctly. This situation can exist for many types of electronics equipment.

To further elucidate the problem and the inventive solution, we here focus on a modulated optical current sensor. See, e.g., U.S. Pat. Nos. 6,166,816, 6,356,351, 6,434,285 and 8,922,194, the disclosures of which are all incorporated here by reference. Such a system is described below with respect to FIG. 1.

Therein, an electrical cable 100 for transmitting a signal from a first environment 102 having a first ground 104 (and first ground potential) to a second environment 106 having a second ground 108 (and second ground potential) or vice versa. An optical current sensor (i.e., the source 110, elements of the sensing mechanism, e.g., as shown in FIG. 1 of the '194 patent referenced above) generally includes an electronics chassis located in a first ground environment (e.g., in a control room), connected by fiber optic and electrical modulator cables to the sensor (i.e., the load 112 which can comprise loops of optical fiber around a current carrying wire) which is located in a second ground environment (e.g., in the outdoor switch yard). The electrical modulation signal passes from the electronics chassis via the electrical cable 100 which, in this example, comprises a twisted wire pair 114 protected by grounded shielding 116, 118. Twisted and shielded cable is used to prevent electromagnetic pickup from disturbing the signal being sent over the cable.

Conventionally, it has been recognized that the cable shield must be broken at some point along the cabling to allow the outdoor shielding 118 to be grounded to the outdoor ground, and the indoor shielding 116 to be grounded to the indoor ground, as shown in FIG. 1 by the gap denoted “Broken shield”. Otherwise, a continuous and unbroken shield would directly connect the outdoor and indoor grounds, which can be different by thousands of volts during a substation fault. Such a voltage difference impressed across a continuous cable shield would cause a large electrical current to flow in the shield, damaging or destroying it, and also disturbing the modulation signal carried by the wires inside the cable at precisely the time (i.e., when a fault occurs) when it is most critical to measure the current in the sensor, whose value is required to take the appropriate action to clear the substation fault.

Besides breaking the shielding, conventional techniques also recognize that it is advantageous to provide a coupling transformer somewhere within the cable (e.g., at the cable/chassis interface, not shown in FIG. 1, but shown in FIG. 2). The coupling transformer provides electrical isolation between its two sides, allowing the common mode voltage of the one side to be very different from that of the other. Isolation transformers providing thousands of volts of common mode isolation are small, low cost, and readily available in the market. A ground potential rise in the outdoor environment tends to raise the common mode voltage of the signal carrying wire pair, but this common mode voltage rise is blocked from back-feeding into the chassis by the transformer isolation.

These two principal elements of the conventional techniques for dealing with the issues associated with significant differences between the two ground potentials described above, i.e., the broken shield and the isolation transformer coupling, have been found in practice to be insufficient for protecting the integrity of the signal passing from one grounding environment to another during an electrical fault in a substation. Accordingly, it is desirable to add additional protections to resolve this problem.

### SUMMARY

According to an embodiment, an electrical communications system is described between a first environment and a second environment, having time-varying ground potential differences. The system includes a wire pair for carrying an electrical signal to be communicated from the first environment to the second environment; a first ground shield surrounding the signal carrying wire pair connected to a ground of the first environment; a second ground shield surrounding the signal carrying wire pair connected to a ground of the second environment; and a resistive element connected between the wires in the signal carrying wire pair having a value chosen so as to suppress any natural resonance characteristics of the cable structure.

According to an embodiment, an electrical communications system between two environments, at least one environment having a time-varying ground potential includes a wire pair for carrying an electrical signal to be communicated from the first environment to the second environment; a first ground shield surrounding the signal carrying wire pair connected to the ground of the first environment; a second ground shield surrounding the signal carrying wire pair connected to the ground of the second environment; a break in a shielding between the first ground shield and the second ground shield; a source connected to the wire pair in the first environment; an isolation transformer connected to the wire pair in the first environment; and a resistive load connected between the wires in the signal carrying wire pair and configured to minimize an error signal induced into the wire pair by the time-varying ground potential.

According to an embodiment, a method for suppressing RF cable resonances within a signal carrying wire pair includes the steps of providing a first environment connected to a first ground potential; providing a second environment connected to a second ground potential different than said first ground potential; shielding said first environment with a first shield through which said signal carrying wire pair passes; shielding said second environment with a second shield through which said signal carrying wire passes; providing a break between said first shield and said second shield; and providing a resistive element between the wires in the signal carrying wire pair.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates two environments associated with an electrical substation and a signal carrying wire pair therebetween;

FIG. 2 illustrates two environments associated with an electrical substation and a signal carrying wire pair therebetween including one or more resistive elements according to an embodiment;

FIG. 3 depicts a lumped element circuit equivalent of the system of FIG. 2 according to an embodiment;

FIG. 4 illustrates an embodiment with an example of an impedance element; and

FIG. 5 is a flow chart showing a method according to an embodiment.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. The embodiments to be discussed next are not limited to the configurations described below, but may be extended to other arrangements as discussed later.

Reference throughout the specification to “one embodiment” or “an embodiment” means that a particular feature, structure or characteristic described in connection with an embodiment is included in at least one embodiment of the present invention. Thus, the appearance of the phrases “in one embodiment” or “in an embodiment” in various places throughout the specification is not necessarily all referring to the same embodiment. Further, the particular features, structures or characteristics may be combined in any suitable manner in one or more embodiments.

As described in the Background section, there are problems associated with the transmission of electrical signals between two environments connected to two different grounds having two different potentials. Prior attempts to deal with this problem involve creating an intentional break or gap in the metal shielding which protects the wiring that carries the signal between the environments and introducing an isolation transformer into the system. According to an embodiment, a third principal element is provided to the interconnection, specifically a resistive circuit element set between the two signal carrying wires that quickly equalizes the common mode voltage between these two wires that is picked up during the ground fault.

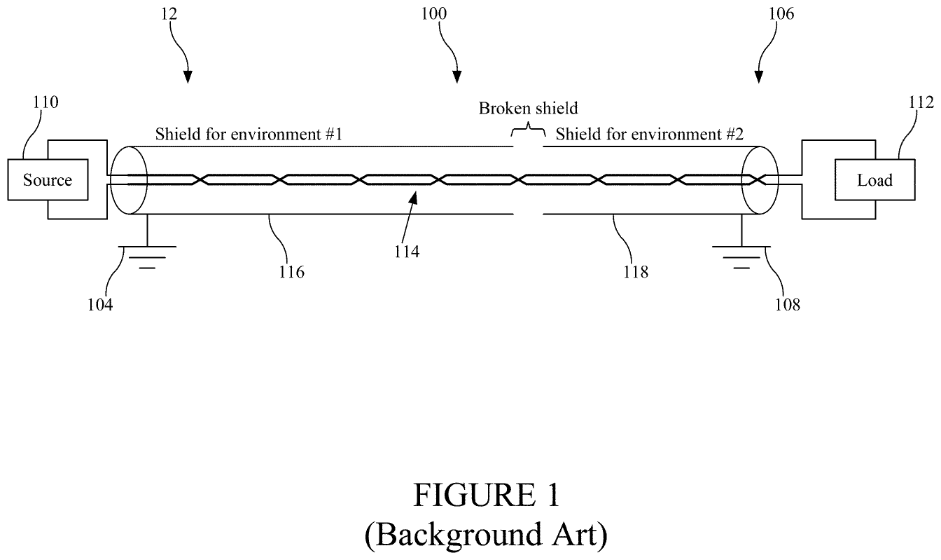

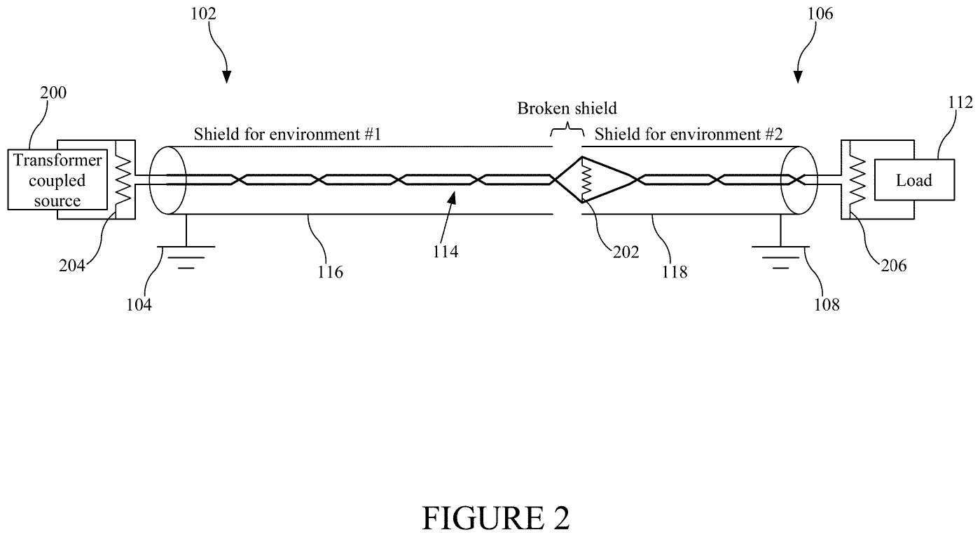

An example of such an embodiment which suppresses differential RF cable resonances within the signal carrying wires is shown in FIG. 2. Those elements which are the same or similar as elements in the system of FIG. 1 are labelled with the same reference numbers used in FIG. 1 and, for brevity, the description thereof is not repeated here. Note, however, that in this embodiment, the source 200 (which can still be elements of an optical current sensor are now indicated to also include an isolation transformer coupled thereto as described in the Background section.) As shown therein, and as one example, a resistive element 202 can be placed between the two signal carrying wires within the cable. Alternatively, or additionally, resistive elements 204 and 206 can be placed between the two wires at the source or load end as shown in FIG. 2, for reasons described below.

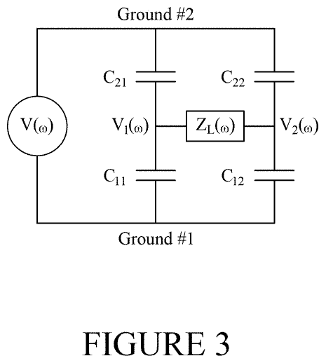

In order to understand how the addition of one or more resistive elements between the two signal carrying wires addresses the problems associated with transmitting a signal between two environments having potentially greatly different ground potentials, this problem is explained in more detail beginning with a discussion of FIG. 3.

FIG. 3 shows a lumped element equivalent circuit diagram of the interconnecting cable passing from one grounding environment to another during a fault. Capacitors model the coupling between the various wires and shields. A generalized impedance is set between the two signal carrying conductors of the cable. Therein C11 is the capacitance between Ground 1 and inner conductor (wire) 1, C12 is the capacitance between Ground 1 and inner conductor (wire) 2, C21 is the capacitance between Ground 2 and inner conductor (wire) 1 and C22 is the capacitance between Ground 2 and inner conductor (wire) 2. ZL(ω) is the frequency dependent impedance between the two inner conductors and is generally comprised of capacitance, C3, inductance, L3, and (possibly) some resistance, R3. More generally, it represents reactance of a transmission line together with any added load impedance.

V(t) represents the voltage potential rise of Ground 2 relative to Ground 1. V(t) can reach several thousand volts in an electrical substation for short periods of time during a substation fault or switching transient, e.g., during or after a lightning strike. V(ω) is the frequency content of V(t). V1(t) is the instantaneous voltage potential of inner conductor (wire) 1. V1(ω) is the frequency content of V1(t). V2(t) is the instantaneous voltage potential of inner conductor (wire) 2. V2(ω) is the frequency content of V2(t).

V1(t)−V2(t) is the electrical error signal being communicated through the cable due to the different ground potentials associated with the two environments (i.e., this is not the desired, modulated signal being conveyed by the twisted pair), and is thus ideally 0 in this analysis which considers only the impact of V(t). However, the embodiments described herein are intended to minimize the value of V1(t)−V2(t) during non-ideal conditions as will be discussed below.

The actual signal to be communicated is suppressed in this analysis using the principle of superposition. Two failure conditions should be considered:

(1) A first failure condition occurs when V1(t)−V2(t) exceeds the breakdown voltage of the wire cabling or any electrical component between the inner conductors. In this case, the signal being transmitted over the cable is shorted and components might even suffer permanent damage. The cable should be designed so that this cannot happen.

(2) A second failure occurs when V1(t)−V2(t) does not exceed the breakdown voltage of the wire cabling or any electrical component connecting the inner conductors. In this case, the signal communication function may or may not be disrupted depending on the severity of the value. The cable should be designed so that the signal communication function is not disrupted.

Transmission line effects arising from a long cable length are ignored in the analysis presented below. Ignoring the transmission line effects in the analysis does not mean that they are not important to the transmission of the signal. However, the physical basis of the principal problem involved is fully evident without complicating the analysis by including the transmission line effects of the cable. We do note that inductance in this “lumped element” analysis may be due not only to the isolation transformer, but also to transmission line effects of distributed capacitance along the cable.

With these assumptions and considerations in mind, an analytical solution for the problem posed by the two different environments linked by a communication cable as described above is solved as follows in equation (1) (using the frequency domain rather than the time domain to simplify the expression):

$$V 1 ( ω ) - V 2 ( ω ) = \frac{j ω Z L ( C 12 * C 21 - C 11 * C 22 )}{\begin{matrix}C 11 + C 12 + C 21 + C 22 + \\ j ω Z L ( C 11 + C 12 ) ( C 21 + C 22 )\end{matrix}} * V ( ω ) \qquad ( 1 )$$

From equation (1), it is evident that there is no error signal if C12*C21=C11*C22. That is, there is no error signal if the two signal wires have equal capacitances coupling to the two different grounds. Immunity to ground rise potential pickup is thus greatly improved by twisting the inner wires. However, it is not practical to expect that the capacitances will be sufficiently balanced to sufficiently suppress the pickup errors when the driving function, V(ω) is thousands of volts, e.g., upon the occurrence of a lightning strike.

In addition, in the case that the impedance between the wires, ZL, has significant inductance (let ZL=jωL3), there exists a resonance frequency, fres, at which the denominator is zero. This frequency is given by:

$${f}_{res} = \frac{1}{2 π} \sqrt{\frac{C 11 + C 12 + C 21 + C 22}{L 3 ( C 11 + C 12 ) ( C 21 + C 22 )}} \qquad ( 2 )$$

It is noted that the error in the signal voltage can become very large due to the resonant characteristics of the cable, consisting of reactive elements, be they capacitances between the various wires, the inductance of the isolation transformer, or a transmission line of a long cable. Both conditions given earlier can easily be violated—the voltage difference between the signal carrying wires of the cable can exceed the breakdown voltage of its weakest constituent element, or it can disrupt the function of the signal being transmitted therethrough.

As mentioned above, embodiments describe herein suppress the resonant structure of the cabling system by adding a real resistive load (which can include one or more resistive elements) between the signal carrying wires as shown in FIG. 2. Ensuring that ZL has a real component suppresses the RF resonance characteristic of the interconnecting cable. Ensuring that ZL has a small magnitude proportionally lowers the total value of the disturbance caused by the ground fault. Consider again equation (1). In order to minimize the value of V1(w)−V2(w), particularly when V(w) is quite large, it is thus desirable to make the fractional multiplier of V(w) in equation (1) to be as small as possible. This aspect suggests two things: (1) the denominator of the fractional multiplier should be non-zero and (2) the numerator of the fractional multiplier should be as small as possible. At first blush, this suggests adding a very small real resistive load between the signal carrying wires. However there are other factors at issue. For example, it is more typically the case in the design of such circuits to provide for loads having a high impedance so that the source has enough power to drive the load. This factor suggests a reason why ZL should instead have a higher value.

Thus, another aspect to these embodiments is to balance these competing factors, i.e., to make ZL small enough that the error signal V1(w)−V2(w) is small, even during situations where the difference between the two ground potentials is very large such that V(w) is also very large, while also making ZL large enough that the source can drive it.

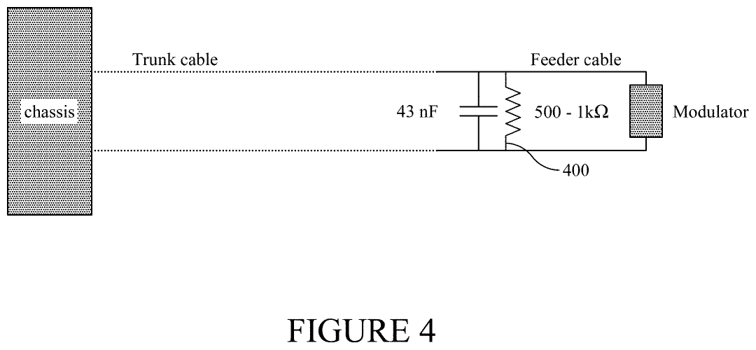

It has been found that such a balance can be found when the real resistive load which is added between the two signal carrying wires has a value of between 100 ohms-5 k ohms. According to one embodiment, which is shown in FIG. 4, the resistive load 400 which is added for these purposes has a value of between 500 ohms and 1 k ohm.

In the case that a long cable run is used, the RF resonance characteristic of the cable may be dominated by the transmission line effects. It is advantageous in this case to add parallel resistance to both ends of the cable to minimize traveling wave reflections from both ends of the cable, e.g., resistive elements 204 and 206 in FIG. 2.

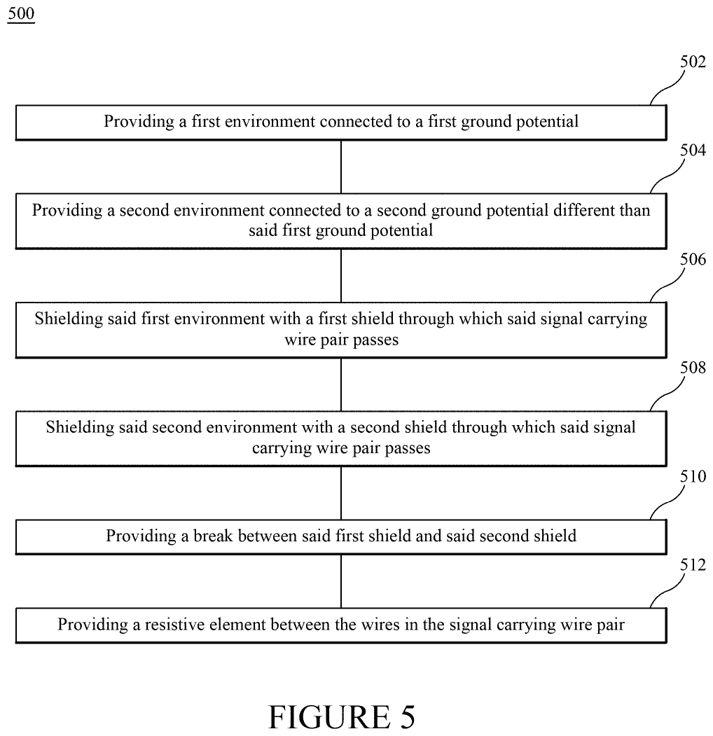

Embodiments can also be expressed as methods or processes, an example of which is illustrated in FIG. 5. Therein, a method for suppressing RF cable resonances within a signal carrying wire pair includes a number of steps (not necessarily performed in the order illustrated). At step 502, a first environment is provided connected to a first ground potential. At step 504, a second environment is provided connected to a second ground potential different than said first ground potential. At step 506, said first environment is shielded with a first shield through which said signal carrying wire pair passes. At step 508, said second environment is shielded with a second shield through which said signal carrying wire passes. At step 510, a break is provided between said first shield and said second shield. At step 512, a resistive element is provided between the wires in the signal carrying wire pair.

Although the features and elements of the present embodiments are described in the embodiments in particular combinations, each feature or element can be used alone without the other features and elements of the embodiments or in various combinations with or without other features and elements disclosed herein. The methods or flowcharts provided in the present application may be implemented in a computer program, software or firmware tangibly embodied in a computer-readable storage medium for execution by a specifically programmed computer or processor.

1. An electrical communications system between a first environment and a second environment, having time-varying ground potential differences, comprising:
a wire pair for carrying an electrical signal to be communicated from the first environment to the second environment;
a first ground shield surrounding the signal carrying wire pair connected to a ground of the first environment;
a second ground shield surrounding the signal carrying wire pair connected to a ground of the second environments; and
a resistive element connected between the wires in the signal carrying wire pair having a value chosen so as to suppress any natural resonance characteristics of the cable structure.

2. The system of claim 1, wherein:
the first environment is a control room of an electrical substation and the second environment is a switchyard of an electrical substation.

3. The system of claim 1, wherein:
the wire pair, the first ground shield and the second ground shield form a cable; and the resistive element connected between the wires in the signal carrying wire pair is divided into two parts, one part located near one end of the cable and the other part located near the other end of the cable.

4. The system of claim 1, wherein the resistive element has a resistance of between 100 ohms and 5 k ohms.

5. The system of claim 1, wherein the resistive element has a resistance of between 500 ohms and 1 k ohms.

6. The system of claim 1, wherein there is a gap between the first ground shield and the second ground shield.

7. The system of claim 1, further comprising a source connected to the wire pair in the first environment and a load connected to the wire pair in the second environment, wherein the source is an optical current sensor and the load is optical current sensing fiber proximate a current carrying wire.

8. An electrical communications system between two environments, at least one environment having a time-varying ground potential, the system comprising:
a wire pair for carrying an electrical signal to be communicated from the first environment to the second environment;
a first ground shield surrounding the signal carrying wire pair connected to the ground of the first environment;
a second ground shield surrounding the signal carrying wire pair connected to the ground of the second environment;
a break in a shielding between the first ground shield and the second ground shield;
a source connected to the wire pair in the first environment; an isolation transformer connected to the wire pair in the first environment; and
a resistive load connected between the wires in the signal carrying wire pair and configured to minimize an error signal induced into the wire pair by the time-varying ground potential.

9. The electrical communications system of claim 8, wherein the resistive load comprises one or more resistive elements.

10. The electrical communications system of claim 8, wherein the resistive load has a value of between 100 ohms and 5 k ohms.

11. The electrical communications system of claim 8, wherein the resistive load has a value of between 500 ohms and 1 k ohms.

12. The electrical communications system of claim 8, further comprising a load connected to the wire pair in the second environment.

13. The electrical communications system of claim 8, wherein the resistive load is connected between the wires in the signal carrying wire pair proximate the source.

14. The electrical communications system of claim 13, wherein the resistive load is connected between the wires in the signal carrying wire pair proximate the load.

15. The electrical communications system of claim 8, wherein the first environment is a control room of an electrical substation and the second environment is a switchyard of an electrical substation.

16. The system of claim 15, wherein the source is an optical current sensor and the load is optical current sensing fiber proximate a current carrying wire.

17. A method for suppressing RF cable resonances within a signal carrying wire pair, the method comprising:
providing a first environment connected to a first ground potential;
providing a second environment connected to a second ground potential different than said first ground potential;
shielding said first environment with a first shield through which said signal carrying wire pair passes;
shielding said second environment with a second shield through which said signal carrying wire passes;
providing a break between said first shield and said second shield; and
providing a resistive element between the wires in the signal carrying wire pair.

18. The method of claim 17, wherein the first environment is a control room of an electrical substation and the second environment is a switchyard of an electrical substation.

19. The method of claim 17, wherein the resistive load has a value of between 100 ohms and 5 k ohms.

20. The method of claim 17, wherein the resistive load has a value of between 500 ohms and 1 k ohms.
